(19) United States
(12) Patent Application Publication
(10) Pub. No.: US 2017/0201356 A1
(43) Pub. Date: Jul. 13, 2017

(54) METHOD AND APPARATUS FOR EXPANDING A MESSAGE COVERAGE

(71) Applicant: Rohde & Schwarz GmbH & Co. KG, Munchen (DE)

(72) Inventors: Sandra Merkel, Munchen (DE); Juergen Schlienz, Poing (DE)

(21) Appl. No.: 14/991,529

(22) Filed: Jan. 8, 2016

(51) Int. Cl. H04L 5/00; H04W 72/00; H04W 4/00; H04W 4/12

(52) U.S. Cl. CPC H04L 5/0007; H04W 4/12; H04W 72/005; H04W 4/008

(57) ABSTRACT

The method and apparatus for expanding a message coverage are disclosed. One method includes transmitting a message (M) by a first user equipment (UE1) as a transmissions sequence (TS) comprising a set of transmissions. The method further includes decoding, by a second user equipment (UE2) at least one transmission (Tᵢ) of a received transmission sequence (TS) and predicting following transmissions (Tᵢ₊₁, Tᵢ₊₂ . . . T_{N}) of said transmission sequence (TS) on the basis of the decoded transmission (Tᵢ). The method further includes transmitting the predicted following transmissions (Tᵢ₊₁, Tᵢ₊₂ . . . T_{N}) of the respective transmission sequence (TS) by said second user equipment (UE2).

### TECHNICAL FIELD

The invention relates to a method and apparatus for expanding a message coverage of messages, in particular device-to-device messages.

### TECHNICAL BACKGROUND

Device-to-device communication allows direct communication between mobile devices. Device-to-device communication does improve spectrum utilization, overall data throughput, and energy consumption, while enabling peer-to-peer and location-based applications and services. Device-to-device communication can be performed between mobile devices integrated in vehicles for information exchange between the vehicles and/or traffic control purposes.

Communication networks such as Long-Term Evolution, LTE, employ base stations such as Node B or evolved Node B base stations. User equipment, UE, devices can communicate with other user equipment devices via at least one base station. Alternatively, it is possible that user equipment devices can communicate with each other directly using resources defined by the network via a direct device-to-device, D2D, communication. For a device-to-device, D2D, communication, resource pools are provided. Different resource pools can be provided for in-coverage and partial coverage communication as well as direct communication. User equipment devices comprise for communication with other user equipment devices a transmitter for transmitting encoded messages and a receiver for receiving messages.

In conventional device-to-device communication systems, where user equipment devices communicate with each other directly via a wireless link, the message coverage is restricted because of the limited transmission range of the transmitters used by the user equipment devices. Further, the environment may lead to distortions and/or reflections of a transmitted message so that the message gets lost or cannot be decoded by a decoding unit of the receiving user equipment.

Accordingly, there is a need to provide a method and apparatus for expanding the message coverage of transmitted messages in a device-to-device communication system.

### SUMMARY OF THE INVENTION

The invention provides according to a first aspect a method for expanding a message coverage, said method comprising:

transmitting a message by a first user equipment as a transmission sequence comprising a set of transmissions, decoding by a second user equipment at least one transmission of a received transmission sequence and predicting following transmissions of said transmission sequence on the basis of the decoded transmission, and transmitting the predicted following transmissions of the respective transmission sequence by the second user equipment.

In a possible embodiment of the method according to the first aspect of the present invention, the transmissions are transmitted by a transmitter of the user equipment using a specific transmission resource pattern within a time-frequency resource grid of an allocated resource pool.

In a further possible embodiment of the method according to the first aspect of the present invention, a method content of the message is encoded by different encoding units of an encoder of the user equipment using encoding processes to generate encoded bitstreams transmitted sequentially by the transmitter of the user equipment as transmissions of the transmission sequence.

In a further possible embodiment of the method according to the first aspect of the present invention, a decoding unit of a decoder of the second user equipment decodes the first decodable bitstream forming a transmission of a transmission sequence received by a receiver of the second user equipment and supplies the decoded bitstream to a predictor of the second user equipment which processes the decoded bitstream to predict following transmissions of the same transmission sequence on the basis of the decoded bitstream and on the basis of a specific transmission resource pattern within a time-frequency resource grid of an allocated resource pool if the predictor is enabled.

In a possible embodiment of the method according to the first aspect of the present invention, the predictor of the user equipment is enabled by a decision unit in response to a resource pool flag and/or in response to a dedicated enablement message received by the second user equipment.

In a still further possible embodiment of the method according to the first aspect of the present invention, the predicted following transmissions of the respective transmission sequence are transmitted by a transmitter of the second user equipment using said specific transmission resource pattern within the time-frequency resource grid of the allocated resource pool.

In a still further possible embodiment of the method according to the first aspect of the present invention, a predictor of a user equipment is enabled to predict transmissions on the basis of a decoded transmission to be transmitted by a transmitter of said user equipment in response to a resource pool allocated to the user equipment and/or in response to an enablement message received by said user equipment from another user equipment or from a base station.

In a still further possible embodiment of the method according to the first aspect of the present invention, the encoding processes used by the different encoding units of the encoder of a user equipment to encode the message content of a message and the corresponding decoding processes are preconfigured in the respective user equipment.

In a further possible embodiment of the method according to the first aspect of the present invention, the encoding processes used by the different encoding units of the encoder of a user equipment to encode the message content of a message and the corresponding decoded processes are configured according to a configuration message received by the respective user equipment from another user equipment or from a base station.

In a still further possible alternative embodiment of the method according to the first aspect of the present invention, the encoding processes used by the different encoding units of the encoder of a user equipment to encode the message content of a message and the corresponding decoding processes are configured according to a decoded transmission indicating the encoding processes to be used by the encoding units of the encoder of the respective user equipment and/or indicating the decoding processes to be used by the decoding units of the decoder of the respective user equipment.

In a still further possible embodiment of the method according to the first aspect of the present invention, the message is a device-to-device broadcast message.

In a still further possible embodiment of the method according to the first aspect of the present invention, the device-to-device broadcast message is a proximity service message.

In a still further possible embodiment of the method according to the first aspect of the present invention, the message content of the message comprises safety-relevant content.

In a still further possible embodiment of the method according to the first aspect of the present invention, the message content of the message comprises comfort-relevant content.

In a still further possible embodiment of the method according to the first aspect of the present invention, the first user equipment and the second user equipment are synchronized.

The invention further provides according to a second aspect a predictor of a user equipment,

said predictor being configured to predict transmissions following a received and successfully decoded transmission within a transmission sequence on the basis of the decoded transmission and on the basis of a specific transmission resource pattern within a time-frequency resource grid of a resource pool allocated to said user equipment.

The invention further provides according to a third aspect a user equipment comprising

an encoder having encoding units configured to encode separately a message content of a message to generate encoded bitstreams,

a transmitter configured to transmit the generated encoded bitstreams sequentially in separate transmissions within a transmission sequence,

a receiver configured to receive transmissions,

a decoder having decoding units configured to decode separately any transmission received by said receiver, and

a predictor adapted to predict transmissions of a transmission sequence following a received transmission decoded by a decoding unit of the decoder on the basis of the successfully decoded transmission,

wherein the predicted transmissions of the respective transmission sequence following the successfully decoded transmission are transmitted by the transmitter of the user equipment.

In a possible embodiment of the user equipment according to the third aspect of the present invention, the transmitter of the user equipment is configured to transmit the transmissions of a transmission sequence using a specific transmission resource pattern within a time-frequency resource grid of an allocated resource pool.

In a possible embodiment of the user equipment according to the third aspect of the present invention, the user equipment is integrated in a mobile device.

In a still further possible embodiment of the user equipment according to the third aspect of the present invention, the user equipment is integrated in a base station communication system.

In a still further possible embodiment, the user equipment according to the third aspect of the present invention is integrated in a vehicle.

The invention further provides according to a fourth aspect a communication system comprising a plurality of user equipment devices adapted to broadcast messages as transmission sequences,

wherein each user equipment device comprises a predictor configured to predict transmissions following a received and successfully decoded transmission within a transmission sequence on the basis of the decoded transmission and on the basis of a specific transmission resource pattern within a time-frequency resource grid of a resource pool allocated to the respective user equipment.

### BRIEF DESCRIPTION OF FIGURES

In the following, possible embodiments of different aspects of the present invention are described in more detail with reference to the enclosed figures.

FIG. 1 shows a block diagram of a possible exemplary embodiment of a user equipment according to an aspect of the present invention;

FIG. 2 shows a flowchart of an exemplary embodiment of a method for expanding a message coverage according to a further aspect of the present invention;

FIG. 3 shows a diagram for illustrating the operation of a method and apparatus according to the present invention;

FIG. 4 shows a signal diagram for illustrating the operation of the method and apparatus according to the present invention;

FIG. 5 shows a diagram for illustrating a possible exemplary scenario where the method and apparatus according to the present invention are employed;

FIG. 6 shows a schematic diagram of an exemplary communication system using the method and apparatus according to the present invention;

FIG. 7 shows a diagram for illustrating a possible exemplary embodiment of a method and apparatus for expanding a message coverage according to the present invention.

### DETAILED DESCRIPTION OF EMBODIMENTS

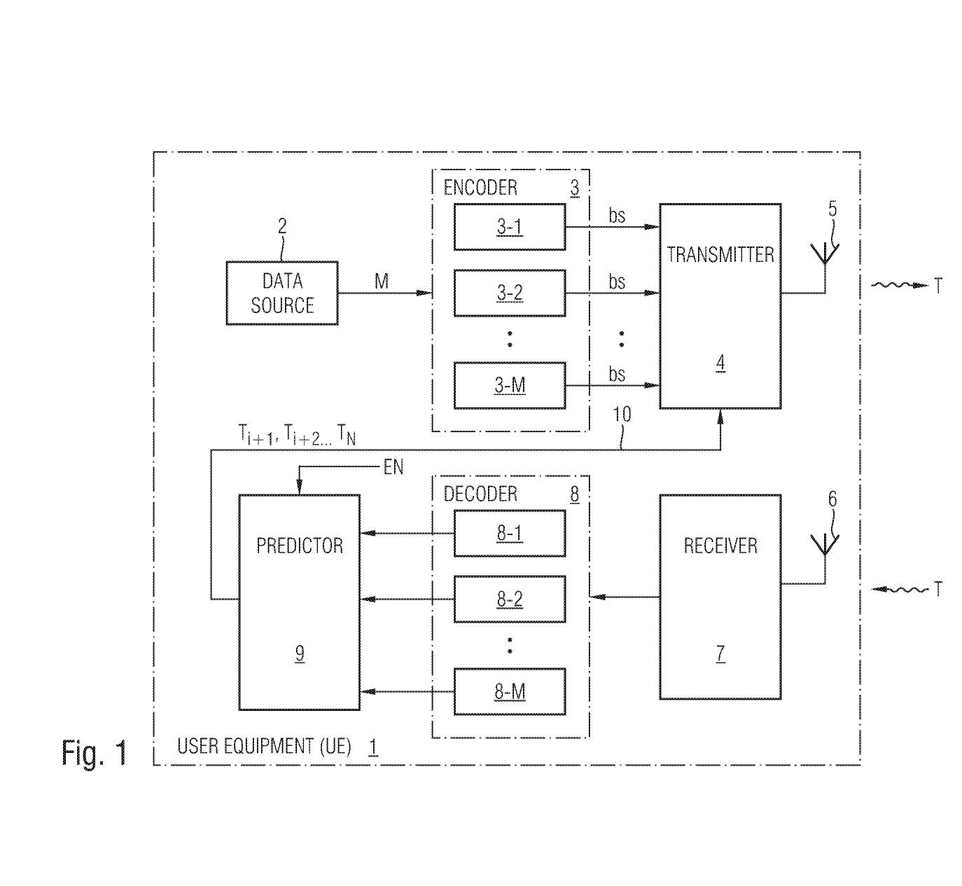

FIG. 1 shows a block diagram of a possible exemplary embodiment of a user equipment 1 according to an aspect of the present invention. The user equipment 1 can be a mobile device, in particular a mobile communication device of a communication system. The user equipment 1 can also be integrated in a mobile device of a vehicle such as a car or truck. The apparatus 1 as illustrated in the block diagram of FIG. 1 can in a possible embodiment also be integrated in a base station of a communication system.

The user equipment 1 can comprise a data source 2 which outputs at least one message having a message content MC. In a possible exemplary embodiment, the data source 2 can be a processing unit of the user equipment device 1 which outputs at least one message M.

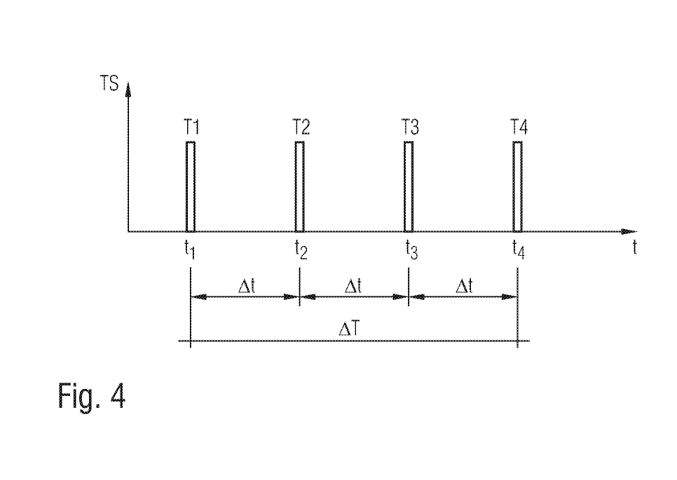

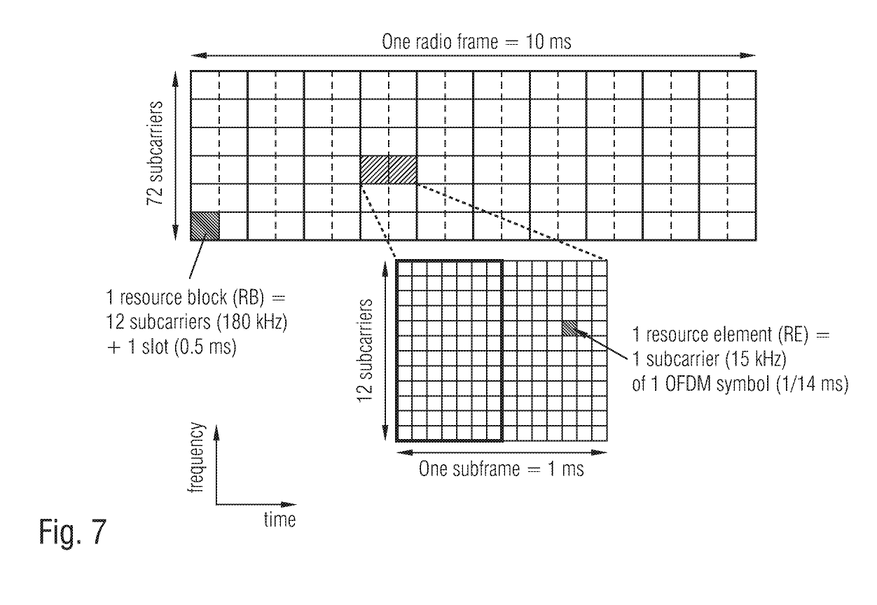

The user equipment 1 comprises an encoder 3 having encoding units 3-1, 3-2 . . . 3-N configured to encode separately the message content MC of the message M to generate encoded bitstreams. The encoded bitstreams bs as illustrated in FIG. 1 are transmitted sequentially by a transmitter 4 in separate transmissions T of a transmission sequence TS. The transmissions can be broadcasted via an antenna 5 of the transmitter 4 as shown in FIG. 1. The transmission sequence TS comprises a number of separate transmissions T as illustrated in FIG. 4. In the exemplary transmission TS shown in FIG. 4, the transmission sequence TS comprises four separate transmissions T which are transmitted by the transmitter 4 sequentially as T1, T2, T3, T4. The number of transmissions of a transmission sequence TS can vary in different embodiments. In the example shown in FIG. 4, the transmission sequence comprises four transmissions T. In a possible embodiment depending on the application, the number N of transmissions T within a transmission sequence TS can be adjustable. The transmissions of the transmission sequence are broadcasted to other user equipment devices in the vicinity of the user equipment 1. In a possible embodiment, the time period between each transmission T of the transmission sequence is fixed and specified in the transmission protocol used by the user equipment devices of the communication system. Also, the number of transmissions within a transmission sequence can be specified in the predetermined data transmission protocol of the communication system. In a possible embodiment, the user equipment 1 is configured to transmit the transmissions or the transmission sequence TS using a specific transmission resource pattern within a time-frequency resource grid of an allocated resource pool as also illustrated in FIG. 7.

The user equipment 1 further comprises a receiving antenna 6 of a receiver 7 configured to receive transmissions from other user equipment devices 1 and/or base stations. The received transmissions are forwarded by the receiver 7 of the user equipment 1 to a decoder 8 of the user equipment 1. The decoder 8 has decoding units 8-1, 8-2 . . . 8-N configured to decode separately any transmission T received by the receiver 7.

The user equipment 1 further comprises a predictor 9 adapted to predict transmissions of a transmission sequence TS following a received transmission Tᵢ decoded by a decoding unit 8-i of the decoder 8 on the basis of the successfully decoded transmission Tᵢ. The predicted transmissions Tᵢ₊₁, Tᵢ₊₂ . . . T_{N} of the respective transmission sequence TS following the successfully decoded transmission Tᵢ are then transmitted by the transmitter 4 of the user equipment 1 as illustrated in FIG. 1. As shown in FIG. 1, the predictor 9 controls the transmitter 4 of the user equipment 1 via a control line 10. The transmitter 4 controlled by the predictor 9 is configured to transmit the transmissions or transmission sequence TS using the specific predetermined transmission resource pattern within a time-frequency resource grid of the allocated resource pool RP.

FIG. 7 shows exemplarily a time-frequency grid which can be used by the method and apparatus according to a specific embodiment of the present invention. As can be seen in FIG. 7, a radio frame of 10 milliseconds can comprise 10 subframes each having a length of 1 ms. Each subframe can comprise two time-slots having 0.5 ms. In the illustrated embodiment, 72 narrow subcarriers can be used for a multicarrier transmission to carry data. In the embodiment shown in FIG. 7, a resource block does encompass 12 subcarriers and a time-slot. A resource element RE within a resource block can comprise one subcarrier in the range of 15 kHz of one OFDM symbol. In a possible embodiment, each user equipment device 1 has an allocated number of resource blocks in the time-frequency grid. The more resource blocks a user equipment device 1 gets allocated and the higher the modulation used in the resource elements, the higher becomes the transmission bit rate. Which resource blocks and how many resource blocks the respective user equipment device 1 gets allocated at a given point in time depends in a preferred embodiment on an advanced scheduling mechanism in the frequency and time dimension. The user equipment device 1 can perform direct communication on subframes which can be divided over the duration of a cycling control period. The user equipment device 1 supporting direct communication with other user equipment devices can operate in a possible embodiment in different modes for resource allocation. In a possible embodiment, the user equipment 1 can request transmission resources from the base station of the network cell and the base station can schedule transmission resources for transmission of cycling control and data. The user equipment 1 is in-coverage for direct communication whenever the user equipment device 1 detects a network cell on a proximity service carrier. If the user equipment device 1 is out-of-coverage it can use a user equipment autonomous resource selection. If the user equipment device 1 is in-coverage it may use scheduled resource allocation or autonomous resource selection.

In a possible embodiment, for resource allocation, a node or station can broadcast periodically a system information block message via a physical broadcast channel. A specific system information block type can contain information related to proximity service, PROSE, direction communication and another specific system information block type can contain information related to proximity service direct discovery. Resources used for direct communication can comprise common device-to-device transmission resources and dedicated device-to-device transmission resources. For example, a resource pool assignment can assign a percentage of the resources to cellular resources, another percentage to common device-to-device transmission resources and a further percentage to dedicated device-to-device transmission resources. By the resource pool allocation, the communication quality for all users and user equipment devices can be optimized.

The transmissions T of the transmission sequence TS are transmitted by the transmitter 4 of the user equipment device 1 using a specific transmission resource pattern within a time-frequency resource grid of an allocated resource pool as illustrated for example in FIG. 7.

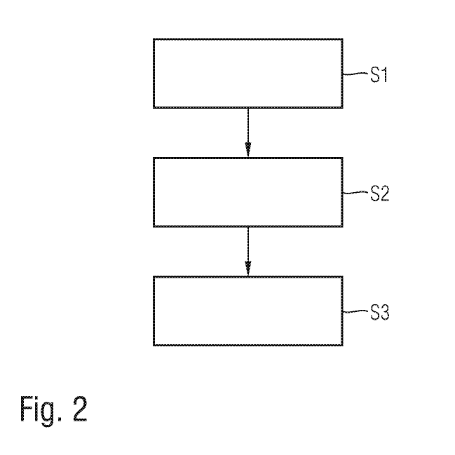

FIG. 2 shows a flowchart of a possible exemplary embodiment of a method for expanding a message coverage according to a further aspect of the present invention.

The method comprises in the illustrated embodiment several steps S1 to S3.

In a first step S1, a message M is transmitted by a first user equipment as a transmission sequence TS comprising a set of transmissions T such as illustrated in FIG. 4.

In a further step S2, at least one transmission Tᵢ of a received transmission sequence TS comprising a number N of transmissions is decoded by a second user equipment and following transmissions of the same transmission sequence TS are predicted by a predictor of the second user equipment on the basis of the at least one decoded transmission Tᵢ within the received transmission sequence TS.

In a further step S3, the predicted following transmissions Tᵢ₊₁, Tᵢ₊₂ . . . T_{N} of the respective transmission sequence TS are transmitted by a transmitter of the second user equipment device.

In a preferred embodiment of the method as illustrated in FIG. 2, the transmissions T are transmitted by a transmitter 4 of the first user equipment device in step S1 using a specific transmission resource pattern within a time-frequency resource grid of an allocated resource pool such as illustrated in FIG. 7. Before transmission a message content MC of the message M is encoded by different encoding units of an encoder of the first user equipment using encoding processes to generate encoded bitstreams bs transmitted sequentially by the transmitter of the first user equipment as transmissions T of the respective transmission sequence TS.

In step S2, a decoding unit of a decoder of the second user equipment decodes the first decodable bitstream forming a transmission of a received transmission sequence TS received by a receiver of the second user equipment.

The decoding unit of the second user equipment then supplies the decoded bitstream to the predictor of the second user equipment device. The predictor 9 of the second user equipment processes the decoded bitstream to predict following transmissions of the same transmission sequence TS on the basis of the decoded bitstream and on the basis of the specific transmission resource pattern within the time-frequency resource grid of the allocated resource pool.

In step S3, the predicted following transmissions of the respective transmission sequence are transmitted by a transmitter 4 of the second user equipment using the specific transmission resource pattern within the time-frequency resource grid of the allocated resource pool.

In a possible embodiment, the prediction is performed by the predictor 9 of the user equipment 1 after the predictor 9 of the user equipment has been enabled. In a possible embodiment, the predictor 9 is enabled by a decision unit of the user equipment in response to a resource pool flag and/or in response to a dedicated enablement message received by the receiver 7 of the second user equipment device. The predictor 9 of the user equipment is enabled to predict transmissions on the basis of a decoded transmission to be transmitted by a transmitter of the user equipment in response to a resource pool allocated to the respective user equipment or in response to an enablement message received by the receiver 7 of the user equipment from another user equipment or from a base station of the communication system.

The encoding processes and/or algorithms used by the different encoding units 3-i of the encoder 3 of the user equipment 1 to encode the message content MC of the message M received from the data source 2 and the corresponding decoding processes and/or decoding algorithms can be are preconfigured in the respective user equipment 1. In an embodiment, the encoding processes used by the different encoding units 3-i of the encoder 3 and the decoding processes used by the decoding units 8-i of the decoder 8 can be configured according to a specific configuration message received by the receiver 7 of the respective user equipment 1 from another user equipment or from a base station of the communication system. In a still further alternative embodiment, the encoding processes used by the different encoding units 3-i of the encoder and/or the corresponding decoding processes of the decoding units 8-i of the decoder 8 are configured according to a decoded transmission Tᵢ of a received transmission sequence indicating the respective encoding processes to be used by the encoding units 3-i of the encoder 3 and/or to be used by the decoding units 8-i of the decoder 8 within the respective user equipment 1.

In a possible embodiment of the method and apparatus according to the present invention, the message M supplied to the encoder 3 is a device-to-device broadcast message, in particular a proximity service message. The message content MC of the message M can comprise in a possible embodiment safety-relevant data content. In another possible embodiment, the message content of the message comprises a comfort-relevant data content.

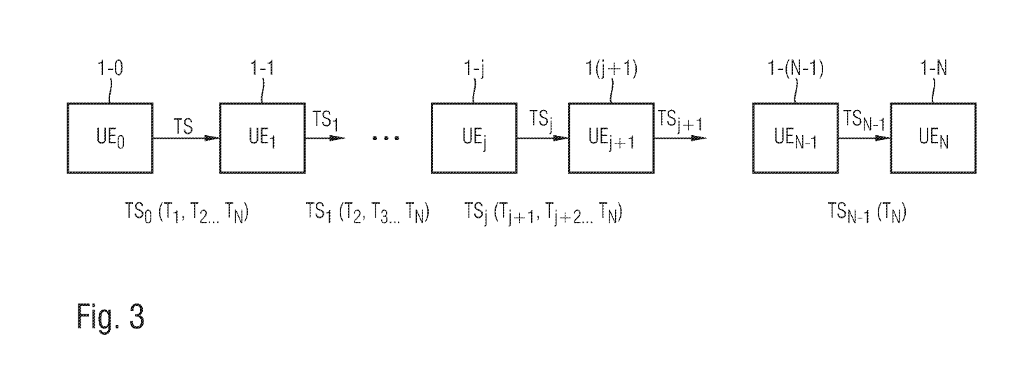

FIG. 3 shows a diagram for illustrating the operation of the method and apparatus according to the different aspects of the present invention for expanding a message coverage of a message M. FIG. 3 shows a chain of user equipment devices 1 as illustrated in FIG. 1. The user equipment devices 1 can be mobile devices which can be mounted in a vehicle. A source user equipment device 1-0 broadcasts a transmission sequence TS₀ comprising several transmissions T1, T2 . . . T_{N} to user equipment devices in its surrounding. In the schematic diagram of FIG. 3, a first user equipment device 1-1 is within the transmission range of the source user equipment device 1-0 and receives the transmission sequence TS₀, for example the transmission sequence shown in FIG. 4. The user equipment device 1-1 decodes at least one transmission Tᵢ of the received transmission sequence TS and predicts following transmissions of the same transmission sequence TS on the basis of the decoded transmission Tᵢ. In the example shown in FIG. 3, the decoder 8 of the user equipment device 1-1 is able of decoding the first transmission T1 of the received transmission sequence TS₀ to predict the following transmissions T2, T3 . . . of the same transmission sequence TS on the basis of the decoded transmission T1. The user equipment device 1-1 then transmits all predicted following transmissions T2, T3 . . . in a transmission sequence TS₁ to other user equipment devices within its surrounding. This process is continued until the last user equipment device UE-n receives the transmission sequence

TS_{N-1} comprising only the last transmission T_{N} of the original transmission sequence TS₀.

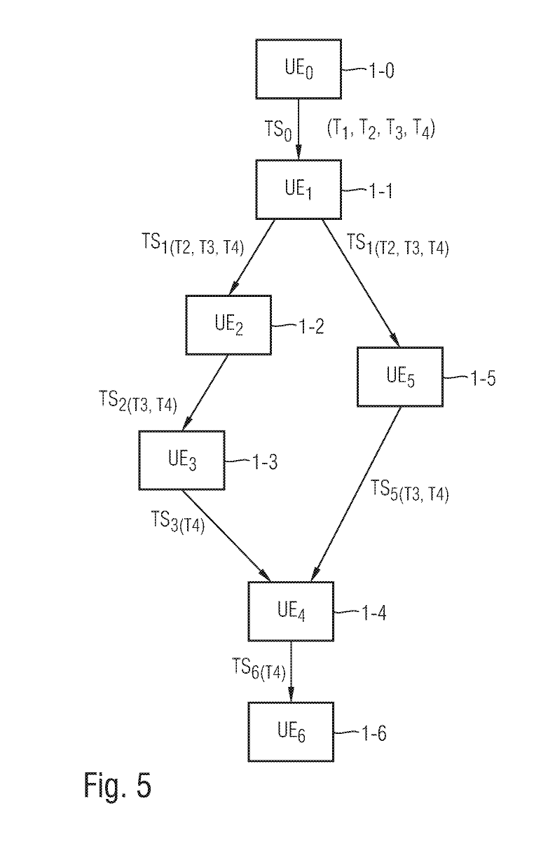

FIG. 5 shows a schematic exemplary scenario for a transmission sequence TS comprising four transmissions T1, T2, T3, T4 and is also illustrated in FIG. 4. The source user equipment device broadcasts the transmission sequence TS₀ encompassing the four transmissions T1 to T4 as shown in FIG. 4 which are captured by a receiver of a first user equipment device 1-1. In the shown example, the decoding unit 8-1 of the decoder 8 of the user equipment device 1-1 shows the first decodable bitstream forming a transmission T1 of the received transmission sequence and supplies the decoded bitstream to the predictor 9 of the user equipment device 1-1. In the given example, the predictor of the user equipment device 1-1 processes the decoded bitstream to predict the following transmissions T2, T3, T4 of the same transmission sequence TS on the basis of the decoded bitstream itself and on the basis of the specific predetermined transmission resource pattern within the time-frequency resource grid of the allocated resource pool. The predicted following transmissions T2, T3, T4 of the transmission sequence TS are then transmitted by the transmitter 4 of the user equipment device 1-1 using the same specific transmission resource pattern within the time-frequency resource grid of the allocated resource pool. The predicted following transmissions T2, T3, T4 are broadcasted to further user equipment devices within the vicinity of the first user equipment device 1-1. In the example of FIG. 5, the receiver of a second user equipment device 1-2 and another fifth user equipment device 1-5 receive the transmission sequence TS1. The decoding unit of the decoder of the second user equipment device 1-2 and the decoding unit of a decoder of the fifth user equipment device 1-5 are able to decode the first decodable bitstream forming a transmission of the received transmission sequence TS1. In the example shown in FIG. 5, the decoder of the second user equipment device 1-2 and of the fifth user equipment device 1-5 are successfully decoding transmission T2 of the received transmission sequence TS1 to predict the following transmissions T3, T4 of the transmission sequence. The predicted transmission sequences are broadcasted by the transmitters 4 of the second user equipment device 1-2 and the fifth user equipment device 1-5 to the surrounding. In the example illustrated in FIG. 5, the receiver 7 of a third user equipment device 1-3 is able to receive the transmissions sequence TS2 broadcasted by the second user equipment device 1-2. The decoder 8 of the third user equipment device 1-3 succeeds in decoding the first transmission T3 of the received transmission sequence TS2 to predict the last transmission T4 of the original transmission sequence on the basis of the decoded bitstream and in response to the specific transmission resource pattern within the time-frequency resource grid of the allocated resource pool. The transmission sequence TS3 transmitted by the third user equipment device 1-3 comprises only one transmission T4, i.e. the last transmission T4 of the original transmission sequence TS₀ broadcasted by the transmitter of the source user equipment device 1-0. In the given example of FIG. 5, the fourth user equipment device 1-4 receives the transmission sequence TS3 including the transmission T4 from the third user equipment device 1-3 and also a fifth transmission sequence TS5 from the fifth user equipment device 1-5 including the transmissions T3, T4. Finally, a decoding unit of the decoder 8 of the fourth user equipment device 1-4 may decode the first decodable bitstream forming the transmission T4 of the received transmission sequence TS3 and/or decode the first decodable bitstream forming a transmission of the other transmission sequence TS5 also received by the receiver 7 of the user equipment device 1-4. In the given example, the decoding unit of the user equipment device 1-4 may be not able for any kind of reasons to decode the transmission T4 of the transmission sequence T3 transmitted by the user equipment device 1-3 but may be able to successfully decode the first transmission T3 of the other transmission sequence TS5 received from the other user equipment device 1-5. The decoded transmission T3 of the transmission sequence TS5 may be supplied to the predictor of the user equipment device 1-4 to predict the following transmission T4 of the original transmission sequence TS0 using the known specific transmission resource pattern within the time-frequency resource grid of the allocated resource pool. The predicted transmission T4 can then be transmitted to a further user equipment device 1-6 as shown in FIG. 5.

As can be seen in FIG. 5, the method and apparatus according to the present invention provide a multipath propagation of transmissions from a source user equipment device to user equipment devices within the vicinity. As illustrated in FIG. 5, an original transmission sequence TS₀ comprising several transmissions Tᵢ can reach via other user equipment devices the user equipment device 1-6 located at a distance exceeding the transmission range of the transmitter 4 of the original source user equipment device 1-0 by far. Because of the multipath propagation via different user equipment devices, for instance via user equipment devices 1-3, 1-5 as shown in FIG. 5, the probability that a user equipment device, such as the user equipment device 1-4 as shown in FIG. 5, receives at least one decodable bitstream forming a transmission T of a transmission sequence TS is highly increased. The method and apparatus according to the present invention allow to increase the transmission range to a wide extent, however, the transmission range is limited by the number of transmissions Tᵢ within the original transmission sequence TS₀. By varying the number of decoded bitstreams forming transmissions of the transmission sequence TS the range of transmission can be adapted to the specific requirements of the specific use case. The method and apparatus have the advantage that they allow to increase the message coverage of an encoded message to a large extent without that additional resources are consumed. The method and apparatus according to the present invention provide a synchronized broadcasting of device-to-device messages where interferences and signal collisions are avoided. The user equipment devices in the vicinity of a broadcasting user equipment device can broadcast themselves the received transmissions of the transmission sequence to notify other user equipment devices in the surrounding. The message content MC of the encoded message forming an encoded bitstream or transmission of a transmission sequence can comprise in a possible embodiment security-relevant information data, for example a warning message. Messages having the same message content are transmitted in a synchronized manner using the same resource elements of a time-frequency resource grid of an allocated resource pool. From the perspective of a receiving user equipment device, different transmission sequences TS are received from different user equipment devices. By this, the coverage of the transmitted message is widely expanded and the probability of collisions with other messages is reduced. With the method and apparatus according to the present invention, the message coverage is expanded without requiring additional resources. Further, the signaling overhead is widely reduced. Moreover, the extent of occupied resources is reduced and consequently the collision probability.

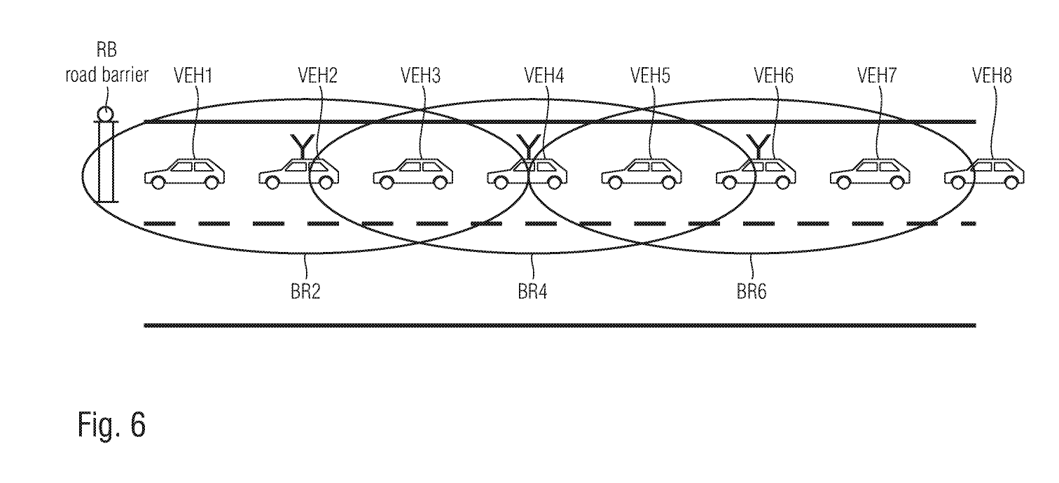

FIG. 6 shows a possible application or use case for the method and apparatus according to the present invention. FIG. 6 illustrates schematically a row of vehicles VEH1 to VEH8 in a traffic jam. In a possible embodiment, most or all vehicles VEH are equipped with a user equipment device 1 as illustrated in FIG. 1. For example, user equipment 1 of the second vehicle 2 has a broadcast range BR2 to reach the receiver of the user equipment 1 integrated in the vehicle VEH4 as shown in FIG. 6. The transmitter of the user equipment 1 within the vehicle VEH4 has a broadcast range BR4 as shown in FIG. 6. Further, the transmitter 4 of the user equipment 1 arranged within the sixth vehicle VEH6 has a broadcast range BR6 as shown in FIG. 6. The transmission sequence TS received by the receiver of the user equipment device within vehicle VEH4 originating from the transmitter of the user equipment device within the second vehicle VEH2 may be evaluated and at least one transmission T of the received transmission sequence TS can be decoded to predict following transmissions of the same transmission sequence TS. The predicted following transmissions can be transmitted or forwarded by the user equipment device 1 within the fourth vehicle VEH4 to reach the user equipment 1 of the sixth vehicle VEH6 within the traffic jam row. The encoded message M may originate for example from the user equipment 1 of the first vehicle VEH1 of the traffic jam row standing for example in front of an obstacle such as a road bar. The message content MC can for instance indicate in a possible embodiment the kind of obstacle having caused the traffic jam or a specific traffic situation. In this way, other vehicles VEH in the traffic jam row are informed by means of device-to-device communication using the method and apparatus according to the present invention about the cause of the traffic jam even when a vehicle VEH is far away from the respective traffic obstacle. The encoded message content of the broadcasted device-to-device message may comprise additional information data provided by other systems of the vehicle, for instance by the navigation system of the vehicle. For instance, in the illustrated example of FIG. 6, the coordinates of the obstacle in front of the vehicle VEH1 may be broadcasted within transmission sequence TS by the user equipment 1 of the first vehicle VEH1 to other user equipment devices. The coordinates may comprise GPS data provided by the navigation system of the first vehicle VEH1. The method and apparatus according to the present invention allows to broadcast information data of interest to other users or user equipment devices in a wider region. The forwarding of transmissions extends the coverage region of the original message. The receiving user equipment device receives multiple transmissions due to multipath propagation as explained in more detail in context with the example illustrated in FIG. 5. The user equipment device having fully decoded a first transmission within a received transmission sequence TS can select the further scheduled redundancies and transmit them. In a possible embodiment, the transmission resources can be coordinated and scheduled by a communication network. The transmission of the same message content MC can be allocated to the same resources using synchronized and identical transmissions. For higher signal frequencies with shorter range, this becomes even more relevant.

The invention provides according to an aspect a communication system comprising a plurality of user equipment devices 1-i each adapted to broadcast messages as transmission sequences TS. This communication system can comprise a traffic control communication system such as illustrated in FIG. 6. The processing of data including the encoding of a message and the decoding of a received bitstream as well as the prediction of following transmissions by the predictor 9 are performed in a preferred embodiment in real time. In a possible implementation, the prediction of following transmissions within a transmission sequence TS is performed by the predictor only if the predictor is enabled by a decision or control unit of the user equipment device 1. This can be performed in a possible embodiment in response to a resource pool flag received by the receiver of the user equipment device. Further, in an alternative embodiment, the predictor is enabled by a decision or control unit of the user equipment device in response to a dedicated enablement message received by the receiver of the user equipment device 1.

In still further possible embodiment of the communication system according to a further aspect of the present invention, the source user equipment device 1-0 transmitting the original transmission sequence TS₀ can also be formed by a user equipment apparatus installed in a fixed device associated to a physical object or apparatus. This object or apparatus can be for instance a traffic control apparatus such as a road bar control unit. For example, a road barrier apparatus may transmit a transmission sequence TS₀ when the corresponding road bar is closed. This transmission sequence TS₀ can be received by a user equipment device 1 of the first vehicle VEH1 standing in front of the closed road barrier. Then, the transmission sequence is forwarded to following user equipment devices of vehicles VEH standing in the traffic road jam before the road bar as illustrated schematically in FIG. 6. The forwarded message content MC of the message M transported by means of the transmission sequence TS can comprise additional relevant traffic control data, for example how long the respective road barrier will be closed. For instance, the message content MC may comprise information data indicating that the road barrier as the traffic obstacle will be closed for 60 seconds or five minutes.

In a further exemplary scenario, the first vehicle VEH1 as illustrated in FIG. 6 may be a police vehicle securing a crash site. In this scenario, the user equipment device 1 of the police vehicle VEH1 may transmit a message by means of a transmission sequence TS indicating that the length of the traffic closure caused by the accident is undefined or unknown.

The transported message content MC decoded by a decoder 8 of a user equipment may be further processed by a processing unit of a user equipment 1. The message content is evaluated by the processing unit and can be supplied, for example, to a navigation system of the respective vehicle. In case of a crash site secured by a police vehicle VEH1, the navigation systems of the following vehicles can use the decoded traffic information to calculate an alternative route around the crash site. Further, in the example illustrated in FIG. 6, control information indicating that a road barrier is closed for a predetermined time of e.g. one minute can be used by a motor control unit of a standing vehicle to switch off the motor of the vehicle for a certain time. In a possible embodiment of the user equipment device 1, the processing unit of the user equipment can take into account also how many transmissions Tᵢ the received transmission sequence does comprise. As shown in the example of FIG. 5, the original transmission sequence T₀ comprises four transmissions T1, T2, T3, T4. In contrast the transmission sequences TS3 and TS6 only comprise one transmission T4. If the received transmission sequence comprises four transmissions, it can be derived that the user equipment is comparatively close to the original source equipment device 1-0, whereas if the transmission sequence does comprise only a few or only one transmission, it can be derived by the processing unit of the receiving user equipment that the user equipment is comparatively far away from the original user equipment device 1-0. This information can be used by different applications. For example, vehicle VEH2 can derive from the number of received transmissions within a transmission sequence TS that it is close to the original source user equipment device 1-0 integrated in a control unit of the road barrier, or alternatively, in the first vehicle VEH1, while the last vehicle VEH8 of the traffic jam row may receive a transmission sequence having only a few or a single transmission. Consequently, the user equipment device of the last vehicle VEH8 can detect that the vehicle is comparatively far away from the road barrier and take this into account when generating control signals adapted to control actuators of the vehicle VEH8. For example, if the message content MC of the message M transported in encoded form by transmissions of a transmission sequence TS indicates that the road barrier will be closed for 60 seconds, the control or processing unit of the first vehicle VEH1 may switch on the motor of the vehicle VEH1 after 60 seconds, whereas the motor control unit of the last vehicle VEH8 may switch on the motor later taking into account that several vehicles or cars stand in front of the last vehicle VEH8 and that the motors of the preceding vehicles VEH1 to VEH7 have first to be switched on to bring the vehicles into motion before the motor of the last vehicle VEH8 can be switched on. Accordingly, in the given example, the processing or control unit of the last vehicle VEH8 receiving a transmission sequence TS including only a few transmissions or a single transmission Tᵢ may switch on the vehicle motor, for example e.g. after 65 seconds. Accordingly, the control of at least one actuator of the vehicle such as a motor can be performed in response to the message content MC of the decoded bitstream but also depending on the number of received transmissions T within the received transmission sequence TS. The number N of transmissions T within a received transmission sequence TS can be evaluated or analyzed to find out how many user equipment devices are located between the original source user equipment device 1-0 and the receiving user equipment device 1-i. If the processing unit of the user equipment device 1 knows the number of transmission sequences T within the original transmission sequence TS₀ (for instance, the number of transmissions is four) it can be easily calculated how many user equipment devices have previously received the transmission sequence and forwarded the transmission sequence. For example, the third user equipment device 1-3 as shown in FIG. 5 receives a transmission sequence TS2 including the transmissions T3, T4 and can derive from that that two user equipment devices 1-1, 1-2 have received the original transmission sequence TS₀ and have forwarded it to the third user equipment device 1-3. Any user equipment device may receive different transmission sequences from different user equipment devices. It is possible to estimate the distance between the respective user equipment device and the original source user equipment device 1-0 from a known transmission range of the used transmitters 4. Further, by evaluating the number of transmissions received from different user equipment devices, a processing unit of the user equipment device can in a possible embodiment estimate the number of user equipment devices in its surrounding, for example the number of user equipment devices within vehicles standing in front of the respective vehicle. For example, a processing unit of the user equipment device 1 within the last vehicle VEH8 in the traffic jam illustrated in FIG. 6 can estimate that seven vehicles VEH1 to VEH7 stand in front of vehicle VEH8 at the road barrier. If the information data broadcasted by the road barrier control unit indicates that the road barrier will be opened after 60 seconds only for a period of 30 seconds, the processing unit of the user equipment device 1 of the vehicle VEH8 may deduce that because of the high number of vehicles in front of it it may not be able to pass the road barrier within the next opening period. This derived information may be used by a navigation system of the vehicle VEH8 to calculate an alternative route to the travel target. If the processing unit of the user equipment device 1 performs in a preferred embodiment the evaluation and processing of the received transmission sequences TS continuously, it is possible to calculate the current traffic density in the vicinity of the vehicle continuously depending on the number of received transmission sequences received from different user equipment devices in the vicinity of the user equipment device of the respective vehicle. Further, current and/or expected delay times can be calculated by a processing unit of the user equipment device 1 on the basis of the decoded message content and/or the number of transmissions T within a received transmission sequence TS.

FIG. 6 shows a use case of a device-to-device communication of user equipment devices implemented in vehicles VEH. The method and apparatus according to the present invention can be used for car-to-car communication but also for car-to-infrastructure communication or even for car-to-person communication. In general, the method and apparatus can be employed in a vehicle to x communication (V2x communication). The decoded message content can comprise safety-relevant content but also comfort-relevant data content. Messages comprising the same content are synchronized and transmitted using the same resource elements of a resource pool.

Further embodiments of the method and apparatus according to the present invention are possible. For example, the signal strength and/or number of transmissions within a transmission sequence TS may be predetermined or adapted. For example, for a very important message M comprising a high priority a number of transmissions Tᵢ within a transmission sequence TS may be increased automatically, thereby increasing implicitly also the message coverage of the respective message M. A less important message may be transported in a transmission sequence comprising only a few transmissions, for instance two or three transmissions, whereas an important message may be transported in a transmission sequence comprising a high number of transmissions, e.g. ten transmissions. By increasing the number of transmissions, the probability or likelihood that at least one transmission can be decoded by a decoding unit of a receiving user equipment device is also increased. Consequently, by increasing the number of transmissions within a transmission sequence not only the transmission range of the forwarded message is increased, but also the probability that a user equipment device will get the corresponding message content.

In a still further possible embodiment, the user equipment device having encoded successfully a transmission of a transmission sequence will not only forward the predicted transmissions of the same transmission sequence, but also acknowledge reception of the transmission sequence to the transmitting user equipment device. The acknowledgement message can also form a message which is transported within a transmission sequence TS back to the original source user equipment device 1-0. In this embodiment, the source user equipment device 1-0 can be informed about user equipment devices in its vicinity which have received the respective message content of the message M. The communication system according to the present invention is very robust against environmental influences and hardware and/or software failures of user equipment devices. As in the example illustrated in FIG. 5, if a user equipment device such as the user equipment device 1-2 fails, the transmission sequence may still reach the fourth user equipment device 1-4 via the fifth user equipment device 1-5. Further, for example, if environmental influences make it impossible to decode any of the transmissions T3, T4 of the transmission sequence TS2 by the decoder of the third user equipment device 1-3, the user equipment device 1-4 may still get the message content by decoding a transmission of the fifth transmission sequence TS5 transmitted by the fifth user equipment device 1-5.

1. A method for expanding a message coverage, said method comprising:
(a) transmitting a message (M) by a first user equipment (UE1) as a transmission sequence (TS) comprising a set of transmissions (T);
(b) decoding by a second user equipment (UE2) at least one transmission (Tᵢ) of a received transmission sequence (TS) and predicting following transmissions (Tᵢ₊1, Tᵢ₊2 . . . T_{N}) of said transmission sequence (TS) on the basis of the decoded transmission (Tᵢ) ; and
(c) transmitting the predicted following transmissions (Tᵢ₊1, Tᵢ₊₂ . . . T_{N}) of the respective transmission sequence (TS) by said second user equipment (UE2).

2. The method according to claim 1, wherein the transmissions (T) are transmitted by a transmitter of said user equipment (UE) using a specific transmission resource pattern within a time-frequency resource grid of an allocated resource pool.

3. The method according to claim 1, wherein a method content (MC) of said message (M) is encoded by different encoding units of an encoder of said user equipment, UE, using encoding processes to generate. encoded bitstreams transmitted sequentially by the transmitter of the user equipment as transmissions (T) of said transmission sequence (TS).

4. The method according to claim 3, wherein a decoding unit of a decoder of the second user equipment (UE2) decodes the first decodable bitstream forming a transmission (T) of a transmission sequence (TS) received by a receiver of said second user equipment (UE2) and supplies the decoded bitstream to a predictor of said second user equipment (UE2) which processes the decoded bitstream to predict following transmissions of the same transmission sequence (TS) on the basis of the decoded bitstream and on the basis of a specific transmission resource pattern within a time-frequency resource grid of an allocated resource pool if the predictor is enabled.

5. The method according to claim 4, wherein the predictor is enabled by a decision unit in response to a resource pool flag and/or in response to a dedicated enablement message received by said second user equipment (UE2).

6. The method according to claim 5, wherein the predicted following transmissions (Tᵢ₊1, Tᵢ₊2 . . . T_{N}) of the respective transmission sequence (TS) are transmitted by a transmitter of the second user equipment (UE2) using said specific transmission resource pattern within the time-frequency resource grid of the allocated resource pool.

7. The method according to claim 5, wherein a predictor of a user equipment (UE) is enabled to predict transmissions on the basis of a decoded transmission to be transmitted by a transmitter of said user equipment (UE) in response to a resource pool allocated to said user equipment (UE) and/or in response to an enablement message received by said user equipment (UE) from another user equipment or from a base station.

8. The method according to claim 3, wherein the encoding processes used by the different encoding units of the encoder of a user equipment (UE) to encode the message content (MC) of a message (M) and the corresponding decoding processes are preconfigured in the respective user equipment (UE) or configured according to a configuration message received by the respective user equipment (UE) from another user equipment or from a base station or configured according to a decoded transmission indicating the encoding processes to be used by the encoding units of the encoder of the respective user equipment (UE).

9. The method according to claim 1, wherein said message (M) is a device-to-device (D2D) broadcast message, in particular a proximity service message.

10. The method according to claim 1, wherein a message content (MC) of said message (M) comprises safety-relevant content or comfort-relevant content.

11. The method according to claim 1, wherein the first user equipment (UE1) and the second user equipment (UE2) are synchronized.

12. A predictor of a user equipment (UE), said predictor being configured to predict transmissions (Tᵢ₊1, Tᵢ₊₂ . . . T_{N}) following a received and successfully decoded transmission (Tᵢ) within a transmission sequence (TS) on the basis of the decoded transmission (Tᵢ) and on the basis of a specific transmission resource pattern within a time-frequency resource grid of a resource pool allocated to said user equipment (UE).

13. A user equipment (UE) comprising:
an encoder having encoding units configured to encode separately a message content (MC) of a message (M) to generate encoded bitstreams;
a transmitter configured to transmit the generated encoded bitstreams sequentially in separate transmissions (T) within a transmission sequence (TS);
a receiver configured to receive transmissions (T);
a decoder having decoding units configured to decode separately any transmission (T) received by said receiver; and
a predictor adapted to predict transmissions of a transmission sequence (TS) following a received transmission (Tᵢ) decoded by a decoding unit of said decoder on the basis of the successfully decoded transmission (Tᵢ) wherein the predicted transmissions (Tᵢ₊1, Tᵢ₊₂ . . . T_{N}) of the respective transmission sequence (TS) following the successfully decoded transmission (Tᵢ) are transmitted by the transmitter of the user equipment (UE).

14. The user equipment according to claim 13, wherein the transmitter of said user equipment (UE) is configured to transmit the transmissions (T) of a transmission sequence (TS) using a specific transmission resource pattern within a time-frequency resource grid of an allocated resource pool (RP).

15. The user equipment according to claim 13, wherein said user equipment (UE) is integrated in a mobile device, a base station or a vehicle.

16. A communication system comprising a plurality of user equipment devices (UE) adapted to broadcast messages (M) as transmission sequences (TS), wherein each user equipment device (UE) comprises a predictor configured to predict transmissions (Tᵢ₊₁, Tᵢ₊₂ . . . T_{N}) following a received and successfully decoded transmission within a transmission sequence (TS) on the basis of the decoded transmission (Tᵢ) and on the basis of a specific transmission resource pattern within a time-frequency resource grid of a resource pool allocated to the respective user equipment (UE).
